(19) United States
(12) Patent Application Publication
(10) Pub. No.: US 2026/0159425 A1
(43) Pub. Date: Jun. 11, 2026

(54) FILTRATION DEVICE FOR WATER INLET PIPE OF SPRINKLER

(71) Applicant: INSTITUTE OF FARMLAND IRRIGATION, CHINESE ACADEMY OF AGRICULTURAL SCIENCES (CAAS), Xinxiang (CN)

(72) Inventors: Hua CAO, Xinxiang (CN); Chunya MA, Xinxiang (CN); Peng LI, Xinxiang (CN); Yongshen FAN, Xinxiang (CN); Wei ZHAN, Xinxiang (CN); Yinbo CAO, Xinxiang (CN); Qingqing JIN, Xinxiang (CN); Xiaotong SUN, Xinxiang (CN)

(21) Appl. No.: 19/304,960

(22) Filed: Aug. 20, 2025

Related U.S. Application Data
(63) Continuation of application No. PCT/CN2025/108323, filed on Jul. 14, 2025.

(30) Foreign Application Priority Data
Dec. 11, 2024 (CN) 202411815908.8

(51) Int. Cl. C02F 1/68; A01C 23/04; A01G 25/02; B01F 21/00; B01F 21/10; B01F 27/07; B01F 27/112; B01F 35/31; B01F 35/32; B01F 35/33; B01F 101/48; B05B 15/40; C02F 1/00

(52) U.S. Cl. CPC C02F 1/685; A01C 23/042; A01G 25/02; B01F 21/10; B01F 21/503; B01F 27/071; B01F 27/112; B01F 35/31; B01F 35/32015; B01F 35/33; B05B 15/40; C02F 1/001; B01F 2101/48

(57) ABSTRACT

The present application provides a filtration device for a water inlet pipe of a sprinkler, which includes a mounting seat provided in the water inlet pipe, and a driving mechanism, the driving mechanism is provided in the mounting seat and penetrates through the mounting seat; a side of the driving mechanism is movably connected to the outer wall of the mounting seat; a clamping mechanism is provided on the driving mechanism, one end of which is fixedly connected to the driving mechanism, and the clamping mechanism is distributed circumferentially around the driving mechanism; a fixing frame with one end connected to the clamping mechanism and another end connected to a filter screen. The filter screen is provided in the water inlet pipe.

### CROSS-REFERENCE TO RELATED APPLICATIONS

This application is a continuation of International Application No. PCT/CN2025/108323, filed on Jul. 14, 2025, and claims priority to a Chinese Application No. 202411815908.8, filed on Dec. 11, 2024, titled “Filtration device for water inlet pipe of sprinkler”, the entire contents of which are hereby incorporated herein by reference in their entirety.

### TECHNICAL FIELD

The present application relates to the technical field of filtering equipment, and specifically relates to a filtration device for a water inlet pipe of a sprinkler.

### BACKGROUND

In the traditional water-soluble fertilizer irrigation system, workers put the required fertilizers into the water-soluble fertilizer tank, and then the water-soluble fertilizers are delivered to the irrigation pipe by the self-priming pump. In this process, since the incoming water contains impurities, it may cause blockage of the water supply pipe or the pipe network.

After the fertilizer is put in, it cannot be fully dissolved in water. The fertilizer is discharged after a too short time of mixing with water, resulting in a low dissolution rate of the fertilizer and reducing the effect of the water-soluble fertilizer. Therefore, a filtration device for a water inlet pipe of a sprinkler is proposed according to the above problems.

### SUMMARY

In view of the deficiencies in the related art, the purpose of the embodiments of the present application is to provide a filtration device for a water inlet pipe of a sprinkler, so as to solve the problems in the above background technology.

To achieve the above purpose, the present application provides the following technical solutions:

A filtration device for a water inlet pipe of a sprinkler, comprising:
a mounting seat provided in the water inlet pipe;
a driving mechanism, provided in the mounting seat and penetrating through the mounting seat, wherein a side of the driving mechanism is movably connected to an outer wall of the mounting seat, and a clamping mechanism is provided on the driving mechanism, one end of the clamping mechanism is fixed to the driving mechanism, and the clamping mechanism is distributed circumferentially around the driving mechanism; and
a fixing frame, with one end connected to the clamping mechanism and another end connected to a filter screen, wherein the filter screen is provided in the water inlet pipe.

In one embodiment, the driving mechanism includes:
a connection shaft, fixed to an inner wall of the mounting seat and penetrating through a driving gear, wherein the connection shaft is movably connected to the driving gear, and the connection shaft is provided at a center of the driving gear;
driven gears, symmetrical about the driving gear and meshing with the driving gear, wherein the driven gears penetrate through the mounting seat and are movably connected to the mounting seat; and
a gear ring, movably connected to an outer wall of the mounting seat and meshing with the driven gears, wherein through holes are symmetrically provided on both sides of the mounting seat, the through holes penetrate through the mounting seat, and the driven gears penetrate through the through holes.

In one embodiment, the clamping mechanism includes:
fixing plates, fixed to the gear ring and evenly distributed circumferentially around the gear ring;
threaded rods, penetrating through the fixing plates, wherein one end of each threaded rod is provided with a connection rotation ball, and the connection rotation ball is movably connected to the threaded rod; and
clamping rods, symmetrical about the connection rotation ball and connected to the fixing frame.

In one embodiment, a threaded hole is provided in the fixing plate, and the threaded rod is movably connected to the fixing plate through the threaded hole.

In one embodiment, the threaded rod is movably connected to the connection rotation ball through the threaded hole, and the connection rotation ball slides on each threaded rod.

In summary, compared with the related art, the embodiments of the present application have the following beneficial effects: the mounting seat is placed in the water inlet pipe of the sprinkler. The two sides of the mounting seat can be fixed on the inner wall of the water inlet pipe, or the mounting seat can be placed in a certain area of the water inlet pipe to rotate freely. When the two sides of the mounting seat are fixed on the inner wall of the water inlet pipe, the water flow will impact the stirring plate, which drives the fixing frame to rotate. The fixing frame drives the clamping mechanism to rotate, and the clamping mechanism drives the driving mechanism to rotate. This ensures that after the fertilizer is put in, it can be fully dissolved in water, prolongs the mixing time of the fertilizer and water, improves the fertilizer dissolution rate, and enhances the effect of the water-soluble fertilizer.

When the mounting seat is placed in a certain area of the water inlet pipe to rotate freely, the water flow will drive the mounting seat to rotate. At this time, the water flow will impact the stirring plate, which drives the fixing frame to rotate. The fixing frame drives the clamping mechanism to rotate, and the clamping mechanism drives the driving mechanism to rotate. And the rotation of the mounting seat itself will increase the turbulence effect of the water flow, improving the dissolution efficiency of the fertilizer, but it will reduce the water flow velocity in the pipe. The installation mode of the mounting seat can be adjusted according to the actual situation.

To clarify the structural features and effects of the present application more clearly, the present application will be described in detail below with reference to the accompanying drawings and specific embodiments.

### BRIEF DESCRIPTION OF THE DRAWINGS

FIG. 1 is a structural view of an embodiment of the present application.

FIG. 2 is a cross-sectional view of FIG. 1 in the embodiment of the present application.

FIG. 3 is a structural view of the driving mechanism in FIG. 2 in the embodiment of the present application.

FIG. 4 is a structural view of part A in FIG. 2 in the embodiment of the present application.

FIG. 5 is a structural view of the clamping mechanism in FIG. 1 in the embodiment of the present application.

### DETAILED DESCRIPTION OF THE EMBODIMENTS

To make the objectives, technical solutions, and advantages of the present application clearer, the present application will be further described in detail below with reference to the accompanying drawings and embodiments. It should be understood that the specific embodiments described herein are only used to explain the present application and are not intended to limit the present application.

The specific implementation of the present application will be described in detail below with reference to specific embodiments.

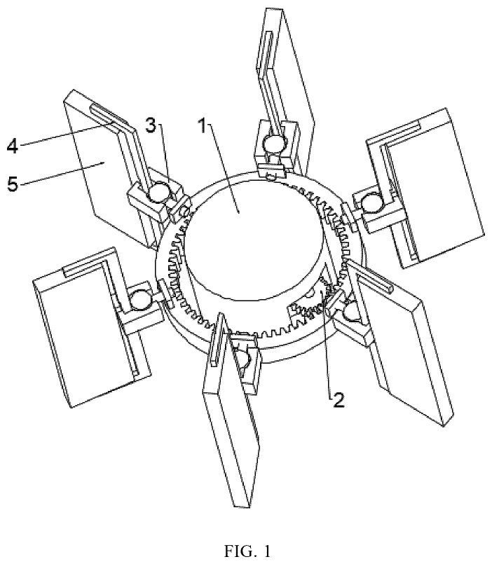

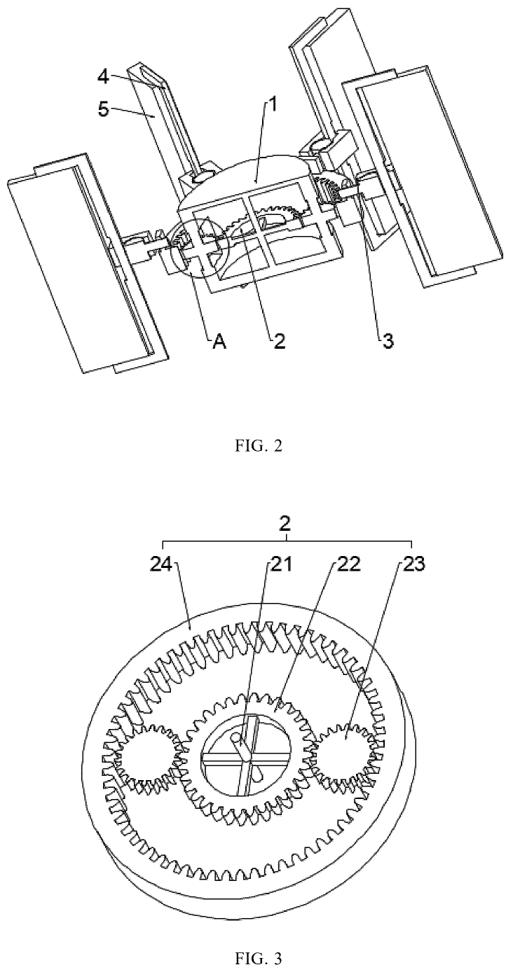

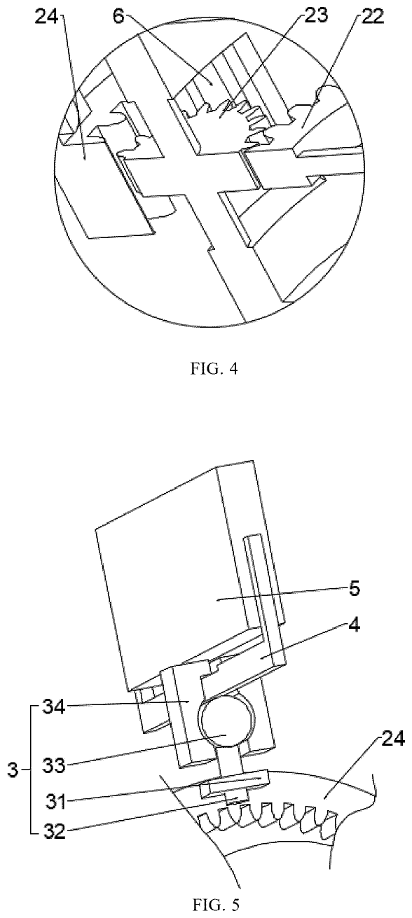

In one embodiment, a filtration device for the water inlet pipe of a sprinkler, referring to FIGS. 1 to 5, includes:
a mounting seat 1 provided in the water inlet pipe;
a driving mechanism 2 provided in the mounting seat 1 and penetrating through the mounting seat 1, one side of the driving mechanism 2 is movably connected to the outer wall of the mounting seat 1, a clamping mechanism 3 is provided on the driving mechanism 2, one end of the clamping mechanism 3 is fixed to the driving mechanism 2, and the clamping mechanism 3 is distributed circumferentially around the driving mechanism 2; and
a fixing frame 4, with one end connected to the clamping mechanism 3 and another end connected to a stirring plate 5. The stirring plate 5 is provided in the water inlet pipe.

In this embodiment, the mounting seat 1 is placed in the water inlet pipe of the sprinkler. The two sides of the mounting seat 1 can be fixed on the inner wall of the water inlet pipe, or the mounting seat 1 can be placed in a certain area of the water inlet pipe to rotate freely. When the two sides of the mounting seat 1 are fixed on the inner wall of the water inlet pipe, the water flow will impact the stirring plate 5, which drives the fixing frame 4 to rotate. The fixing frame 4 drives the clamping mechanism 3 to rotate, and the clamping mechanism 3 drives the driving mechanism 2 to rotate. This ensures that after the fertilizer is put in, it can be fully dissolved in water, prolongs the mixing time of the fertilizer and water, improves the fertilizer dissolution rate, and enhances the effect of the water-soluble fertilizer.

When the mounting seat 1 is placed in a certain area of the water inlet pipe to rotate freely, the water flow will drive the mounting seat 1 to rotate. At this time, the water flow will impact the stirring plate 5, which drives the fixing frame 4 to rotate. The fixing frame 4 drives the clamping mechanism 3 to rotate, and the clamping mechanism 3 drives the driving mechanism 2 to rotate. And the rotation of the mounting seat 1 itself will increase the turbulence effect of the water flow, improving the dissolution efficiency of the fertilizer, but it will reduce the water flow velocity in the pipe. The installation mode of the mounting seat 1 can be adjusted according to the actual situation.

In one embodiment, referring to FIGS. 1 to 5, the driving mechanism 2 includes:
a connection shaft 21, which is fixed to the inner wall of the mounting seat 1 and penetrates through a driving gear 22, the connection shaft 21 is movably connected to the driving gear 22;
driven gears 23, which are symmetrical about the driving gear 22 and mesh with the driving gear 22, the driven gears 23 penetrate through the mounting seat 1 and are movably connected to the mounting seat 1; and
a gear ring 24, which is movably connected to the outer wall of the mounting seat 1 and meshes with the driven gears 23.

Further, referring to FIGS. 1 to 5, the connection shaft 21 is provided at the center of the driving gear 22.

Further, referring to FIGS. 1 to 5, through holes 6 are symmetrically provided on both sides of the mounting seat 1, the through holes 6 penetrate through the mounting seat 1, and the driven gears 23 penetrate through the through holes 6.

In this embodiment, when the two sides of the mounting seat 1 are fixed on the inner wall of the water inlet pipe, or the mounting seat 1 is placed in a certain area of the water inlet pipe to rotate freely, the water flow will impact the stirring plate 5, which drives the fixing frame 4 to rotate. The fixing frame 4 drives the clamping mechanism 3 to rotate, and the clamping mechanism 3 drives the gear ring 24 to rotate. The symmetrical driven gears 23 can ensure that the gear ring 24 does not shift during rotation, ensuring smooth rotation, and the driven gears 23 rotate around the driving gear 22.

In one embodiment, referring to FIGS. 1 to 5, the clamping mechanism 3 includes:
fixing plates 31, fixed to the gear ring 24 and evenly distributed circumferentially around the gear ring 24;
threaded rods 32, which penetrate through the fixing plates 31, one end of each threaded rod 32 is provided with a connection rotation ball 33, and the connection rotation ball 33 is movably connected to the threaded rod 32; and
clamping rods 34, symmetrical about the connection rotation ball 33 and connected to the fixing frame 4.

Further, referring to FIGS. 1 to 5, a threaded hole is provided in the fixing plate 31, and the threaded rod 32 is movably connected to the fixing plate 31 through the threaded hole.

Further, referring to FIGS. 1 to 5, the threaded rod 32 is movably connected to the connection rotation ball 33 through the threaded hole, and the connection rotation ball 33 slides on the threaded rod 32.

In this embodiment, after working in the water pipe and during the stirring process of the fertilizer, if the stirring plate 5 is damaged due to fertilizer collision, the mounting seat 1 can be taken out. At this time, the threaded rod 32 is rotated, and the threaded rod 32 drives the connection rotation ball 33 to move toward the fixing plate 31. At this time, the connection rotation ball 33 drives the symmetrical clamping rods 34 to open, so as to take out the fixing frame 4. After replacing or removing the fixing frame 4, the stirring plate 5 can be better stored and replaced with a new one.

The working principle of the present application is:
the mounting seat 1 is placed in the water inlet pipe of the sprinkler. The two sides of the mounting seat 1 can be fixed on the inner wall of the water inlet pipe, or the mounting seat 1 can be placed in a certain area of the water inlet pipe to rotate freely. When the two sides of the mounting seat 1 are fixed on the inner wall of the water inlet pipe, the water flow will impact the stirring plate 5, which drives the fixing frame 4 to rotate. The fixing frame 4 drives the clamping mechanism 3 to rotate, and the clamping mechanism 3 drives the driving mechanism 2 to rotate. After the fertilizer is put in, it can be fully dissolved in water, prolongs the mixing time of the fertilizer and water, improves the fertilizer dissolution rate, and enhances the effect of the water-soluble fertilizer.

When the mounting seat 1 is placed in a certain area of the water inlet pipe to rotate freely, the water flow will drive the mounting seat 1 to rotate. At this time, the water flow will impact the stirring plate 5, which drives the fixing frame 4 to rotate. The fixing frame 4 drives the clamping mechanism 3 to rotate, and the clamping mechanism 3 drives the driving mechanism 2 to rotate. And the rotation of the mounting seat 1 itself will increase the turbulence effect of the water flow, improving the dissolution efficiency of the fertilizer, but it will reduce the water flow velocity in the pipe. The installation mode of the mounting seat 1 can be adjusted according to the actual situation. The above descriptions are only preferred embodiments of the present application and are not intended to limit the present application.

Any modifications, equivalent replacements, and improvements made within the spirit and principles of the present application should be included in the protection scope of the present application.

What is claimed is:

1. A filtration device for a water inlet pipe of a sprinkler, comprising:
a mounting seat, provided in the water inlet pipe;
a driving mechanism, provided in the mounting seat and penetrating through the mounting seat, wherein a side of the driving mechanism is movably connected to an outer wall of the mounting seat, and a clamping mechanism is provided on the driving mechanism, one end of the clamping mechanism is fixed to the driving mechanism, and the clamping mechanism is distributed circumferentially around the driving mechanism; and
a fixing frame, with one end connected to the clamping mechanism and another end connected to a filter screen, wherein the filter screen is provided in the water inlet pipe;
wherein the driving mechanism comprises:
a connection shaft, fixed to an inner wall of the mounting seat and penetrating through a driving gear, wherein the connection shaft is movably connected to the driving gear, and the connection shaft is provided at a center of the driving gear;
driven gears, symmetrical about the driving gear and meshing with the driving gear, wherein the driven gears penetrate through the mounting seat and are movably connected to the mounting seat; and
a gear ring, movably connected to an outer wall of the mounting seat and meshing with the driven gears, wherein through holes are symmetrically provided on both sides of the mounting seat, the through holes penetrate through the mounting seat, and the driven gears penetrate through the through holes.

2. The filtration device for the water inlet pipe of the sprinkler according to claim 1, wherein the clamping mechanism comprises:
fixing plates, fixed to the gear ring and evenly distributed circumferentially around the gear ring;
threaded rods, penetrating through the fixing plates, wherein one end of each threaded rod is provided with a connection rotation ball, and the connection rotation ball is movably connected to the threaded rod; and
clamping rods, symmetrical about the connection rotation ball and connected to the fixing frame.

3. The filtration device for the water inlet pipe of the sprinkler according to claim 2, wherein a threaded hole is provided in the fixing plate, and the threaded rod is movably connected to the fixing plate through the threaded hole.

4. The filtration device for the water inlet pipe of the sprinkler according to claim 3, wherein the threaded rod is movably connected to the connection rotation ball through the threaded hole, and the connection rotation ball slides on each threaded rod.
